(19) United States
(12) Patent Application Publication
(10) Pub. No.: US 2014/0265171 A1
(43) Pub. Date: Sep. 18, 2014

(54) Gear system to assist with transportation on uneven ground and stairs

(71) Applicant: Kavya Ramakrishnan, Palo Alto, CA (US)

(72) Inventor: Kavya Ramakrishnan, Palo Alto, CA (US)

(21) Appl. No.: 13/831,662

(22) Filed: Mar. 15, 2013

(51) Int. Cl. A61G 5/06

(52) U.S. Cl. CPC A61G 5/06
USPC 280/5.28

(57) ABSTRACT

A gear system to assist with transportation on uneven ground and stairs comprising three or more axle systems with outer gears that all mesh with inner gears so that the axle systems, which are supported at either end by a triangle bracket secured by bushings, turn in the same direction. When attached to a vehicle traveling on a flat surface, the gear system has one axle system in the air and two axle systems on the ground, forming a triangle. When the vehicle drives forward, if the axle system on the ground in the front encounters any unevenness, such as rocks or stairs, the entire gear system will rotate toward the front around the axle that is through the inner gear, as the vehicle continues to move forward throughout the rotation. This prevents any uneasy movements and allows the vehicle to fluidly traverse uneven ground or climb stairs.

### CROSS-REFERENCE TO RELATED APPLICATIONS

Not applicable.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

1. Field of the Invention

This invention is a gear system to assist with transportation on uneven ground and stairs.

2. Description of Prior Art

People have difficulty ascending and descending stairs or traveling on uneven terrain in many vehicles, especially wheelchairs and research exploration vehicles. The first stair-climbing wheelchair was introduced in 1986. Today, manufacturing of these designs has slowed down, and there is a need for a better model to address this issue.

This invention is a gear system that can be used to assist with using stairs comfortably and with maneuvering on rough, bumpy terrain. This unique gear system has three wheels and the whole system rotates when it encounters any large objects, such as stairs or rocks, so that, at any time, two of the three wheels will be touching the ground. This also helps avoid uneasy, jerky movements.

### BRIEF SUMMARY OF THE INVENTION

This invention is a unique gear system that allows vehicles to smoothly traverse uneven ground or climb stairs. The framework of this invention contains three gears attached to wheels on either side that mesh with the same inner gear so that they rotate in the same direction. When the vehicle is on flat ground, two wheels are on the ground at any given time, with the third in the air, forming an equilateral triangle shape with the base of the triangle parallel to and touching the ground. Every time a vehicle drives forward and encounters any obstacles or stairs, the entire system rotates so that the wheels switch places: the one that was previously farthest from the vehicle on the ground, in the front, moves to the rear, the position closest to the vehicle on the ground. Similarly, the one that was previously in the rear moves to the air, and the one that was previously in the air moves to the front. The vehicle continues to drive forward throughout the rotation.

This invention is both simple and effective, and, unlike other systems, it is easily adaptable to fit most vehicles. Additionally, the gear system is unique and different. Previous designs are very slow and therefore inefficient. As a result, they may reduce the speed of the entire vehicle. Additionally, they are not compliant with many different types of vehicles. Previous designs are not versatile and are specific to the machine they are built for, such as a wheelchair or a rover. Because of this immense specificity, these other designs are incapable of adjustment. Also, the designs are slow due to the complexity of many mechanical systems. In this invention, the gear system is functionally separate from the other subsystems of the machine, which makes it versatile and compliant with many different types of vehicles. This design is also very simple and does not require multiple moving parts and different types of motion.

### BRIEF DESCRIPTION OF THE SEVERAL VIEWS OF THE DRAWING

FIG. 1 shows a trimetric view of the gear system showing the entire gear system in detail, providing a complete view of the system.

FIG. 2 shows a side view of the gear system showing the side of the gear system in detail and providing a visual for the meshing of the three outer gears with the inner one.

FIG. 3 shows a top view of the gear system in detail.

### DETAILED DESCRIPTION OF THE INVENTION

The components of the gear system are listed as follows and will henceforth be referred to by their respective item numbers and notated as follows on the figures where applicable.

Item Number 1: Outer gear

Item Number 2: Inner gear

Item Number 3: Wheel

Item Number 4: Triangle bracket

Item Number 5: Axle

Item Number 6: Bushing

Item Number 7: Axle System
7a: Axle System in the Air
7b: Front Axle System
7c: Rear Axle System

Item Number W: Width

An axle (5) is threaded through an outer gear (1), such as a 40-tooth gear, two wheels (3) and another outer gear (1). Each wheel (3) has a radius that is slightly larger than that of the outer gear (1). Each axle (5) is slightly longer than the combined width (W on FIG. 3) of two wheels (3), two outer gears (1), two triangle brackets (4), and two bushings (6). This combination, an axle system (7), is created three times. The bushings (6) for the inner gears (2), such as 24-tooth gears, should be positioned with the hole at the center of the triangle bracket (4). Each of the inner gears (2) should be attached to opposite ends of the same axle (5), and then the axle (5) should be put through a bushing (6) on each triangle bracket (4) (refer to FIG. 3). The axle (5) should be positioned so that the gears (2) are flush with their respective bushings (6). Three bushings (6) are attached to each triangle bracket (4) from one side to another and positioned so that when the axle systems (7) are put through the hole in the bushings (6), each outer gear (1) on its respective axle (5) meshes with the inner gear (2) but does not mesh with the other outer gears (refer to FIG. 2). This is to ensure that the axle systems (7) turn in the same direction and do not bind, or get stuck.

The outer gears (1) rotate in the same direction as each other because they all mesh with the inner gears (2). The outer gears (1) are attached to wheels (3) in axle systems (7) that enable the vehicle to drive on the ground. The axle systems (7) are supported at either end by a triangle bracket (4) and secured by bushings (6) so that the gear system does not fall apart. On a flat surface, the gear system has one axle system (7) that is always in the air while the other two axle systems (7) are parallel to and touching the ground. Therefore, the three axle systems (7) are arranged in a triangle. When the vehicle drives forward without any obstruction, each axle system (7) rotates independently. As shown in FIG. 2, when the vehicle drives forward, if the axle system on the ground in the front (7b) encounters any unevenness, such as rocks or stairs, the entire gear system will rotate toward the front around the axle (5) that is through the inner gear (2), as the vehicle continues to move forward. After the rotation is complete, the axle system that was previously in the air (7a) will have moved to the front, as shown in FIG. 2. The axle system that was previously in the front (7b) will have moved to the ground towards the rear. Similarly, the axle system that was previously on the ground towards the rear (7c) will have moved to be in the air. The vehicle continues to drive forward throughout the rotation.

To use this gear system, a person must construct it to the proportions that are required for his vehicle, and then attach the gear system to his vehicle in a way that suits him. There is no need to power the gear system because the forward momentum of the vehicle will cause the gear system to rotate toward the front. There should be enough clearance between the vehicle and the gear system to allow the axle systems to rotate freely.

For example, when the vehicle is a car, a person can attach the gear system to the front fender of the vehicle with two bars with holes at the ends of both bars that are pointed away from the vehicle. An axle may be threaded through the holes to support the gear system. This is just one possibility for attaching the gear system, and the invention is not limited to being attached by only this method but can be attached in a variety of ways. The vehicle should function normally with the gear system attached.

The gear system should be assembled to desired proportions to fit the size of the vehicle in question. The general design is the same for any vehicle, but the materials and size required may vary by vehicle to increase durability and effectiveness. For example, because of the added heat from the sun, the material used to help a vehicle travel over rough terrain in the desert may not be the same as the material used to help a vehicle climb stairs indoors in an urban environment. The invention can be attached to the vehicle as necessary as previously described. Adjustability in wheel and axle size could improve the ease of usage.

These specifications are for a triangular gear system. In place of a triangle bracket, another geometric shape can be used for a differently shaped gear system, such as a square. The number of vertices of the bracket will determine the number of axle systems. The triangular system is optimal because it uses the least amount of resources and the triangle shape is the most effective and strong. However, the same principle used for the triangular gear system can be successfully applied to a square or other geometric shaped gear system.

The creation of this gear system results in a device that can be attached to a vehicle to assist with transportation on uneven ground and stairs. However, the basic design of having an inner gear rotate several other gears simultaneously could alternatively be applied to a variety of other uses; for example, this invention could be used in pharmaceuticals and medicine to rotate test tubes and test tube holders when injecting into them.

Although a particular embodiment of the gear system has been described in detail for purposes of illustration, other embodiments of the invention will be apparent to those skilled in art from consideration of the specification and practice of the invention disclosed herein. It is intended that the specification and examples be considered as exemplary only, with a true scope and spirit of the invention being indicated by the following claims.

1. A gear system for attachment to a vehicle traveling in a forward direction over a surface, the gear system comprising:
a first axle system that is positioned to contact the surface toward a front side of the vehicle;
a second axle system that is positioned to contact the surface toward a rear side of the vehicle;
a third axle system that is positioned to not contact the surface; and
a center axle,
wherein, in a case where the vehicle encounters an obstruction, each of the first axle system, the second axle system, and the third axle system rotates in the forward direction around the center axle,
wherein, after the rotation is complete, (i) the first axle system is positioned to contact the surface toward the rear side of the vehicle, (ii) the second axle system is positioned to not contact the surface, and (iii) the third axle system is positioned to contact the surface toward the front side of the vehicle, and
wherein the vehicle continues to travel in the forward direction throughout the rotation of the first axle system, the second axle system, and the third axle system.

2. The gear system of claim 1, wherein the first axle system comprises:
two gears;
two wheels;
two bushings; and
an axle.

3. The gear system of claim 2, wherein a diameter of the wheels is larger than a diameter of the gears.

4. The gear system of claim 2, wherein a length of the axle is greater than a combined width of the two wheels, the two gears, and the two bushings.

5. The gear system of claim 2, wherein the two gears are 40-tooth gears.

6. The gear system of claim 2, further comprising an inner gear,
wherein the inner gear is capable of meshing with a gear of the first axle system.

7. The gear system of claim 6, wherein the inner gear is a 24-tooth gear.

8. The gear system of claim 1, further comprising a triangular bracket,
wherein the first, second, and third axle systems are attached at the vertices of the triangular bracket such that the axle systems are arranged in a triangle shape.

9. The gear system of claim 1, further comprising:
a fourth axle system that is positioned to not contact the surface; and
a square bracket,
wherein the first, second, third, and fourth axle systems are attached to the vertices of the square bracket such that the axle systems are arranged in a square shape,
wherein, in a case where the vehicle encounters a second obstruction, each of the first axle system, the second axle system, the third axle system, and the fourth axle system performs a second rotation in the forward direction around the center axle, and
wherein, after the second rotation is complete, (i) the first axle system is positioned to not contact the surface, (ii) the second axle system is positioned to not contact the surface, and (iii) the third axle system is positioned to contact the surface toward the rear side of the vehicle, and (iv) the fourth axle system is positioned to contact the surface toward the front side of the vehicle.
